(19) United States
(12) Patent Application Publication
(10) Pub. No.: US 2022/0198785 A1
(43) Pub. Date: Jun. 23, 2022

(54) INSPECTION DEVICE AND INSPECTION METHOD

(71) Applicant: Musashi AI Limited, Toyohashi-shi (JP)

(72) Inventors: Sota MURATA, Toyohashi-shi (JP); Keisuke FUJITA, Toyohashi-shi (JP); Fumihisa KAMIYA, Toyohashi-shi (JP)

(73) Assignee: Musashi AI Limited, Toyohashi-shi (JP)

(21) Appl. No.: 17/598,756

(22) PCT Filed: Mar. 29, 2019
(86) PCT No.: PCT/JP2019/014229

§ 371 Date: Sep. 27, 2021

(51) Int. Cl. G06V 10/774

(52) U.S. Cl. CPC G06V 10/7747

(57) ABSTRACT

Inspection is efficiently performed without lowering inspection accuracy, by performing an inspection using AI processing. An inspection device has a learning unit that generates a learning model by performing learning for discriminating a type of an inspection object by using as teacher data at least a part of classification results obtained by classifying a plurality of inspected objects of a same type as an inspection object into a plurality of types, or acquires the learning model, a calculation unit that outputs numerical data obtained by quantifying a level of classification accuracy of the type of the inspection object, based on a result calculated by inputting the inspection object to the learning model, and a determination unit that determines, by comparing the numerical data with types of thresholds, whether to automatically discriminate the type of the inspection object or to manually discriminate the type of the inspection object.

### TECHNICAL FIELD

The present invention relates to an inspection device and an inspection method using a learning model.

### BACKGROUND ART

Efforts have been actively made to automate processing that has conventionally been manually performed by a human using machine learning such as deep learning. In artificial intelligence (AI) processing using machine learning, for example, a plurality of pieces of teacher data are input to generate a learning model, input data is given to a generated learning model to perform calculation, and AI processing data on which a result of the machine learning is reflected is output (JP 2019-039874 A).

Conventionally, a technique for performing machine learning by controlling a weight given to each node of a neural network in a learning process has been applied to various fields. Recently, not only the supervised learning but also a technology of performing AI processing by performing the unsupervised learning has been advanced, and inference processing such as Go (name of a board game) in which there are an infinite number of possible combinations is becoming to be performed at much higher speed and with higher accuracy than by a human.

### SUMMARY OF INVENTION

Against a background of labor shortage, suppression of labor costs, and the like, a wide variety of robots are introduced into manufacturing sites, and various products are manufactured fully automatically or semi-automatically. Although a product is inspected after production, automation of an inspection process has not progressed so much at present. This is because there are various factors causing defects, and the inspection is still often performed by relying on manpower.

For example, with regard to an appearance inspection of a product, a skilled person determines whether it should be treated as a defect depending on a size, location, type, and the like of a flaw on the basis of many years of experience. Therefore, it is necessary to secure a sufficient number of skilled workers.

The present invention provides an inspection device and an inspection method capable of efficiently performing an inspection without lowering inspection accuracy, by performing an inspection using AI processing.

To solve the above problem, in one aspect of the present invention, there is provided an inspection device including:

a learning unit that generates a learning model by performing learning for discriminating a type of an inspection object by using as teacher data at least a part of classification results obtained by classifying a plurality of inspected objects of a same type as an inspection object into a plurality of types, or acquires the learning model;

a calculation unit that outputs numerical data obtained by quantifying a level of classification accuracy of the type of the inspection object, based on a result calculated by inputting the inspection object to the learning model; and

a determination unit that determines, based on a result of comparing the numerical data with one or more types of thresholds, whether to automatically discriminate the type of the inspection object or to manually discriminate the type of the inspection object.

The inspection device may include a threshold calculation unit that calculates the one or more types of thresholds, based on a plurality of pieces of the numerical data calculated by inputting a plurality of inspection objects to the learning model.

The threshold calculation unit may calculate the one or more types of thresholds by statistically processing the plurality of pieces of the numerical data.

The one or more types of thresholds may include a first threshold and a second threshold larger than the first threshold, and

when the numerical data is between the first threshold and the second threshold, the determination unit may determine to manually discriminate the type of the inspection object.

When the numerical data is smaller than the first threshold or the numerical data is larger than the second threshold, the determination unit may determine to automatically discriminate the type of the inspection object instead of manually discriminating the type of the inspection object.

The inspection device may include:

a relearning unit that, when the numerical data is between the first threshold and the second threshold, generates a relearning model by performing relearning, based on unique information of the inspection object or acquires the learning model; and

a recalculation unit that outputs again the numerical data, based on a result of calculated by inputting the inspection object to the relearning model, and

the determination unit may determine, while taking into consideration the unique information of the inspection object, whether to automatically discriminate the type of the inspection object based on a result of comparing the numerical data with the first threshold and the second threshold or to manually discriminate the type of the inspection object.

The determination unit may determine, based on the first threshold and the second threshold set for each type of the unique information of the inspection object, whether to automatically discriminate the type of the inspection object for the each type of the unique information of the inspection object or to manually discriminate the type of the inspection object.

The plurality of types may include a non-defective type and a defective type, and

the unique information may include defect sizes of a non-defective product and a defective product.

The inspection device may include a practical level determination unit that determines whether a rate of the numerical data included between the first threshold and the second threshold has become less than a third threshold and that determines, when the rate is determined to have become less than the third threshold, that the learning model has reached a practical level.

In a case where a frequency at which the inspection object is classified into a specific type is less than a fourth threshold when classification of the same inspection object has been performed a plurality of times, the determination unit may determine to manually discriminate the type of the inspection object.

The inspection device may include

a photographing unit that photographs the inspection object from a plurality of directions, and

the learning unit may use, as the teacher data, a plurality of photographed images of the inspection object photographed by the photographing unit.

The inspection device may include a visualization unit that visualizes the numerical data calculated by inputting a plurality of inspection objects to the learning model.

Another aspect of the present invention is an inspection method for inspecting an inspection object performed by a computer, the inspection method, performed by the computer, including:

generating a learning model by performing learning for discriminating a type of an inspection object by using as teacher data at least a part of classification results obtained by classifying a plurality of inspected objects of a same type as the inspection object into a plurality of types, or acquiring the learning model;

outputting numerical data obtained by quantifying a level of classification accuracy of the type of the inspection object, based on a result of calculated by inputting the inspection object to the learning model; and

determining, based on a result of comparing the numerical data with one or more types of thresholds, whether to automatically discriminate the type of the inspection object or to manually discriminate the type of the inspection object.

The computer connected to a network may be configured to:

transmit the teacher data and the data of the inspection object to the computer via the network, and

receive, via the network, information on whether to automatically discriminate the type of the inspection object or to manually discriminate the type of the inspection object, the information being determined by the computer.

The computer may be configured to calculate the one or more types of thresholds, based on a plurality of pieces of the numerical data calculated by inputting a plurality of the inspection objects to the learning model.

The computer may be configured to calculate the one or more types of thresholds by statistically processing the plurality of pieces of the numerical data.

The one or more types of thresholds may include a first threshold and a second threshold larger than the first threshold, and

the computer may be configured to determine to manually discriminate the type of the inspection object when the numerical data is between the first threshold and the second threshold.

The computer may be configured to determine, when the numerical data is smaller than the first threshold or the numerical data is larger than the second threshold, to automatically discriminate the type of the inspection object instead of manually discriminating the type of the inspection object.

The computer may be configured to:

generate, when the numerical data is between the first threshold and the second threshold, a relearning model by performing relearning based on unique information of the inspection object or acquiring the relearning model;

output again the numerical data, based on a result calculated by inputting the inspection object to the relearning model; and

determine, while taking into consideration the unique information of the inspection object, whether to automatically discriminate the type of the inspection object based on a result of comparing the numerical data with the first threshold and the second threshold or to manually discriminate the type of the inspection object.

The computer may be configured to determine, based on the first threshold and the second threshold set for each type of the unique information of the inspection object, whether to automatically discriminate the type of the inspection object for each type of the unique information of the inspection object or to manually discriminate the type of the inspection object.

The plurality of types may include a non-defective type and a defective type, and

the unique information may include defect sizes of a non-defective product and a defective product.

The computer may be configured to determine whether a rate of the numerical data included between the first threshold and the second threshold has become less than a third threshold, and determine, when the rate is determined to have become less than the third threshold, that the learning model has reached a practical level.

The computer may be configured to determine to manually discriminate the type of the inspection object, in a case where a frequency at which the inspection object is classified into a specific type is less than a fourth threshold when classification of the same inspection object has been performed a plurality of times.

A plurality of photographed images of the inspection object photographed from a plurality of directions may be used as the teacher data.

The computer may be configured to visualize the numerical data calculated by inputting a plurality of inspection objects to the learning model.

With the present invention, by performing inspection using AI processing, it is possible to efficiently perform inspection without lowering inspection accuracy.

### BRIEF DESCRIPTION OF DRAWINGS

FIG. 1 is a block diagram illustrating a schematic configuration of an inspection device according to a first embodiment.

FIG. 2 is a block diagram illustrating an internal configuration of an AI processing unit.

FIG. 3 is a plot diagram showing inspection results of a plurality of inspection objects.

FIG. 4 is a plot diagram on which a first and second thresholds are set.

FIG. 5 is a flowchart illustrating a processing operation of the inspection device according to the first embodiment.

FIG. 6 is a graph illustrating how a rate of a manual inspection decreases by repeating learning on the basis of the flowchart of FIG. 5.

FIG. 7 is a block diagram illustrating an internal configuration of an AI processing unit according to a second embodiment.

FIG. 8 is a flowchart illustrating a processing operation of the inspection device according to the second embodiment.

FIG. 9 is a block diagram illustrating an internal configuration of an AI processing unit according to a third embodiment.

FIG. 10 is a plot diagram showing inspection results of a plurality of inspection objects.

FIG. 11 is a flowchart illustrating a processing operation of the inspection device according to the third embodiment.

FIG. 12 is a plot diagram illustrating a result when a discrimination of whether a non-defective product or a defective product was performed by a worker for a plurality of inspected objects over a plurality of times.

### DESCRIPTION OF EMBODIMENTS

Hereinafter, embodiments of the present invention will be described with reference to the drawings. In the following embodiments, characteristic configurations and operations in an inspection device will be mainly described, but the inspection device can have configurations and operations that are omitted in the following description. However, those omitted configurations and operations are also included in the scope of the present embodiments.

### First Embodiment

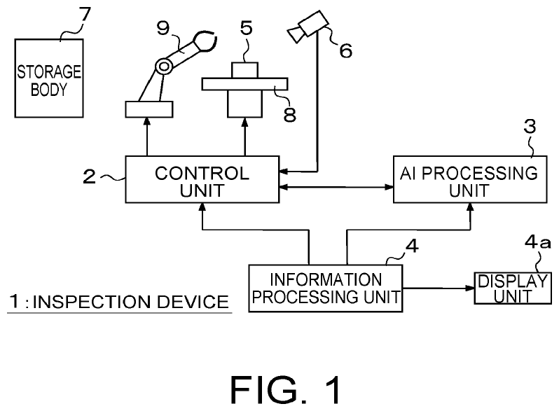

FIG. 1 is a block diagram illustrating a schematic configuration of an inspection device 1 according to a first embodiment. The inspection device 1 of FIG. 1 performs an appearance inspection of an inspection object 5. A type of the inspection object 5 is not particularly limited. A typical example is a plurality of products manufactured according to predetermined specifications. In more specific examples include: a forged product obtained by pressing a metal material or the like with a mold; and a cast product molded by pouring a metal material or the like into a mold. A shape, size, material, and the like of the inspection object 5 are arbitrary, and the inspection object 5 may be formed of not only metal but also resin or the like.

The inspection device 1 of FIG. 1 includes a control unit 2, an AI processing unit 3, and an information processing unit 4. The control unit 2, the AI processing unit 3, and the information processing unit 4 have a communication function of transmitting and receiving information to and from each other. This communication function may be a wireless communication function such as wireless LAN or proximity wireless communication, or may be a wired communication function such as Ethernet (registered trademark) or a universal serial bus (USB). Further, at least two of the control unit 2, the AI processing unit 3, and the information processing unit 4 may be integrated into one housing or a silicon on chip (SoC). Further, at least a part of processing operations performed by the control unit 2, the AI processing unit 3, and the information processing unit 4 may be executed by either hardware or software.

The control unit 2 generates teacher data to be given to the AI processing unit 3 by using a photographed image photographed by a photographing unit 6, and controls to generate inspection object data of an inspection object 5. Since it is considered to perform the appearance inspection of the inspection object 5 in the present embodiment, the photographed image obtained by photographing an appearance of the inspection object 5 by the photographing unit 6 is transmitted as the inspection object data from the control unit 2 to the AI processing unit 3. In addition, the photographed image obtained by photographing, by the photographing unit 6, the appearance of the inspection object 5 that has been discriminated into a non-defective product or a defective product is transmitted as teacher data from the control unit 2 to the AI processing unit 3. Note that the teacher data is at least a part of classification results obtained by classifying, into a plurality of types, a plurality of inspected objects of the same type as the inspection object. The expression “a plurality of types” indicates a plurality of classes into which features such as a shape, characteristic, and size of the inspected object and the inspection object are classified. More specifically, the teacher data may be supervised data including a photographed image that has been discriminated into a non-defective product or a defective product, or may be unsupervised data including a photographed image of only one of a non-defective product and a defective product.

The control unit 2 in FIG. 1 has a function of controlling a robot 9 that sequentially holds the inspection object 5 from a storage body 7 storing the inspection objects 5 and conveys the inspection object 5 to a rotary stage 8. The robot 9 does not have to perform a work of placing the inspection object 5 on the rotary stage 8, and a worker may manually place the inspection object 5 on the rotary stage 8.

The photographing unit 6 is disposed, for example, obliquely above the rotary stage 8. The position and number of the photographing units 6 are arbitrary. By photographing the inspection object 5 on the rotary stage 8 with the photographing unit 6 while rotating the rotary stage 8, the entire appearance of a single inspection object 5 can be photographed in a plurality of photographed images. As described above, in the present embodiment, a plurality of photographed images are generated in order to perform an appearance inspection of one inspection object 5. Regarding the inspection object 5 that has been discriminated into a non-defective product or a defective product, the teacher data to which information indicating the discrimination result of the discrimination between a non-defective product and a defective product is added is generated for each photographed image. Regarding the inspection object 5 that will be discriminated into a non-defective product or a defective product from now on, the photographed images photographed by the photographing unit 6 are the inspection object data.

Note that, depending on the inspection object 5, the entire appearance of the inspection object 5 may be photographed in only one photographed image. In this case, one teacher data and one inspection object data are generated for each inspection object 5.

The AI processing unit 3 inspects the inspection object 5 by AI processing. Here, the AI processing refers to outputting AI processing data obtained by giving input data to a learning model generated by machine learning and then performing calculation. Regarding the machine learning, various learning methods have been proposed, and an arbitrary learning method can be applied to the AI processing of the present embodiment.

The information processing unit 4 automatically generates a program to be executed by the control unit 2 and a program to be executed by the AI processing unit 3. The information processing unit 4 includes a display unit 4a that displays a UI screen having a plurality of input fields for a worker to fill in. When the worker inputs various information in the input fields in accordance with the UI screen displayed on the display unit 4a, the program to be executed by the control unit 2 and the program to be executed by the AI processing unit 3 are automatically generated. The automatically generated programs are transmitted to respective ones of the control unit 2 and the AI processing unit 3 via the communication function of the information processing unit 4. By executing the program transmitted from the information processing unit 4, the control unit 2 performs a control of the robot 9, a photographing control of the inspection object 5, a control of transmitting the inspection object data to the AI processing unit 3 described above, and other controls. In addition, by executing the program transmitted from the information processing unit 4, the AI processing unit 3 performs a reception control of the inspection object data transmitted from the control unit 2 and AI processing on the inspection object data.

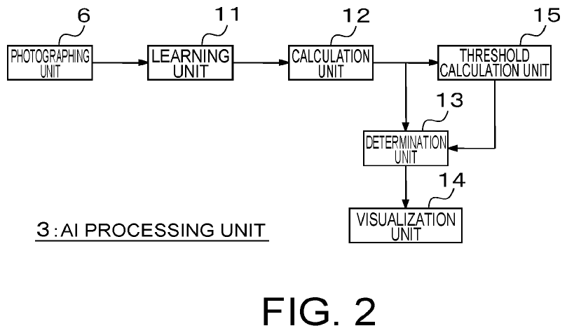

FIG. 2 is a block diagram illustrating an internal configuration of the AI processing unit 3. The AI processing unit 3 includes a learning unit 11, a calculation unit 12, and a determination unit 13.

The learning unit 11 generates a learning model by performing learning for discriminating between a non-defective product and a defective product, using as teacher data at least one of a plurality of non-defective products and defective products of the same type as the inspection object 5. The learning model can be generated by controlling a weighting factor or the like of a model formula prepared in advance, but there is no limitation to a specific model formula to be used to generate the learning model, and any model formula can be applied.

The calculation unit 12 outputs numerical data obtained by quantifying a possibility of a non-defective product or a defective product, based on a result of calculation by inputting an inspection object 5 to the learning model. The numerical data is data to be used for relative evaluation and is not data having a physical unit.

The determination unit 13 determines, based on a result of comparing the numerical data with one or more types of thresholds, whether or not to perform an automatic determination (discrimination) of a non-defective product or a defective product by using numerical data, or determines to perform a manual inspection (discrimination) of whether a non-defective product or a defective product. That is, the determination unit 13 determines to perform an automatic determination only when it is possible to perform determination of a non-defective product or a defective product with high reliability by the AI processing by the AI processing unit 3, and determines to perform a manual inspection when otherwise. This arrangement prevents the inspection accuracy by the present inspection device 1 from being inferior to the inspection accuracy of a manual inspection.

The determination result made by the determination unit 13 is displayed on, for example, the display unit 4a of the AI processing unit 3 or of the information processing unit 4. Based on the display on the display unit 4a, the worker determines whether to perform automatic discrimination or to perform inspection by the worker itself.

Further, the AI processing unit 3 or the information processing unit 4 may include a visualization unit 14. The visualization unit 14 visualizes the numerical data calculated by inputting a plurality of inspection objects 5 to the learning model. As will be described later, for example, the following measure may be taken: each piece of numerical data is displayed as a plot on a two-dimensional coordinate plane in which a horizontal axis represents numerical data and a vertical axis represents a work number of the inspection object 5 so that a distribution of the plots can be visually grasped. In addition, because the visualization unit 14 can distinctively display plots determined by a person as non-defective products and plots determined by a person as defective products, it is easy to grasp a correlation between the non-defective products and defective products and the numerical data.

Further, the AI processing unit 3 may include a threshold calculation unit 15. The threshold calculation unit 15 calculates one or more types of thresholds, based on a plurality of pieces of numerical data calculated by inputting a plurality of inspection objects 5 to the learning model. For example, when the numerical data of the inspection objects 5 determined to be a non-defective product by a worker and the numerical data of an inspection objects 5 determined to be the defective product by the worker are close to each other, the threshold calculation unit 15 may set the threshold between these numerical data. The threshold calculation unit 15 may calculate one or more types of thresholds by statistical processing of a plurality of pieces of numerical data. Here, the statistical processing may be average processing or distribution processing of the plurality of pieces of numerical data, or may be the Mahalanobis-Taguchi (MT) method or the like.

The thresholds calculated by the threshold calculation unit 15 may include, for example, a first threshold and a second threshold larger than the first threshold. When the numerical data is between the first threshold and the second threshold, the determination unit 13 may determine to perform a manual inspection of whether a non-defective product or a defective product. That is, when the numerical data is smaller than the first threshold or larger than the second threshold, the determination unit 13 may determine to perform the automatic determination of a non-defective product or a defective product by the AI processing unit 3 instead of performing the manual inspection of whether a non-defective product or a defective product, and when the numerical data is between the first threshold and the second threshold, the determination unit 13 determines to perform the manual inspection of whether a non-defective product or a defective product.

Next, an inspection process of the inspection device 1 of FIG. 1 will be described. Hereinafter, a description will be given on an example in which an appearance inspection is performed on a predetermined inspection object 5 manufactured by pressing a metal material with a mold. More specifically, in the present inspection example, the control unit 2 performs photographing by the photographing unit 6 while rotating the inspection object 5 placed on the rotary stage 8 to prepare, for example, 36 photographed images for a single inspection object 5, and divides each photographed image into, for example, 8 pieces to generate a total of 36×8=288 pieces of inspection object data. The inspection device 1 of FIG. 1 performs inspection of whether a non-defective product or a defective product for each piece of inspection object data. As a result, 288 types of inspection object data are inspected for one inspection object 5. The number of pieces of inspection object data for a single inspection object 5 is arbitrary.

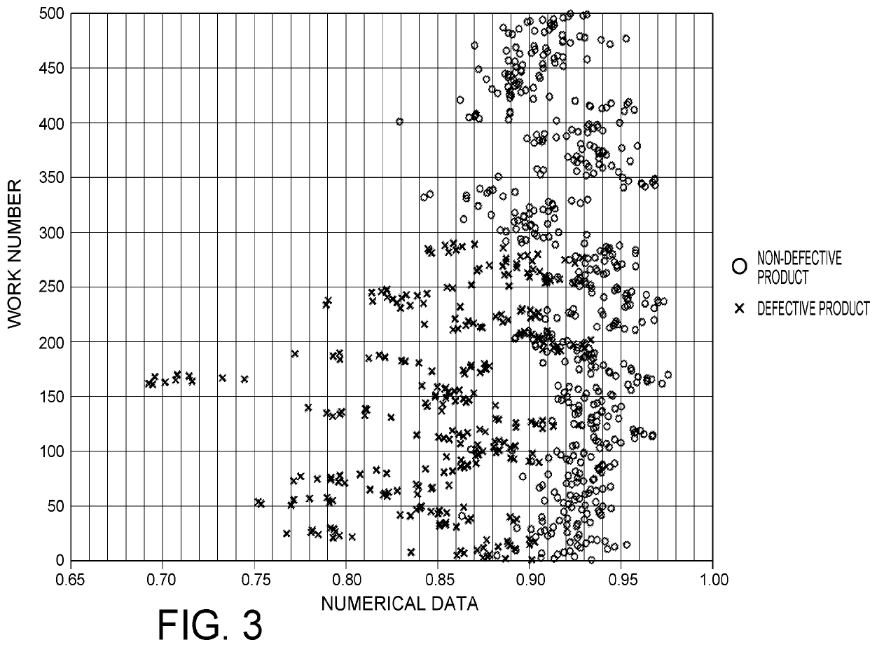

FIG. 3 is a plot diagram illustrating inspection results of a plurality of inspection objects 5. With reference to FIG. 3, numerical data is calculated by the AI processing unit 3 with respect to 288 pieces of inspection object data for each inspection object 5, and plots ◯ and plots × are distinctively shown to respectively represent the worker's judgment of a non-defective product and a defective product for each inspection object data. In this inspection, a different work number is assigned to each piece of inspection object data, and the vertical axis in FIG. 3 represents the work number. The horizontal axis in FIG. 3 represents numerical data calculated by the AI processing unit 3, and the value of the numerical data is larger toward the right side.

As can be seen from the distribution of the plots in FIG. 3, the numerical data of the inspection object data determined to be a non-defective product by the worker gather in the right side direction of the horizontal axis in FIG. 3, and in contrast, the numerical data of the inspection object data determined to be a defective product by the worker is dispersed in a large area on the left side on the horizontal axis in FIG. 3.

Looking at the distribution of the plots in FIG. 3, there is a region where the plots determined to be non-defective products by the worker and the plots determined to be defective products are mixed. Since the AI processing unit 3 compares the numerical data with a threshold to discriminate between a non-defective product and a defective product, there is a possibility that the inspection accuracy of the AI processing unit is lower in an area where non-defective products and defective products are mixed.

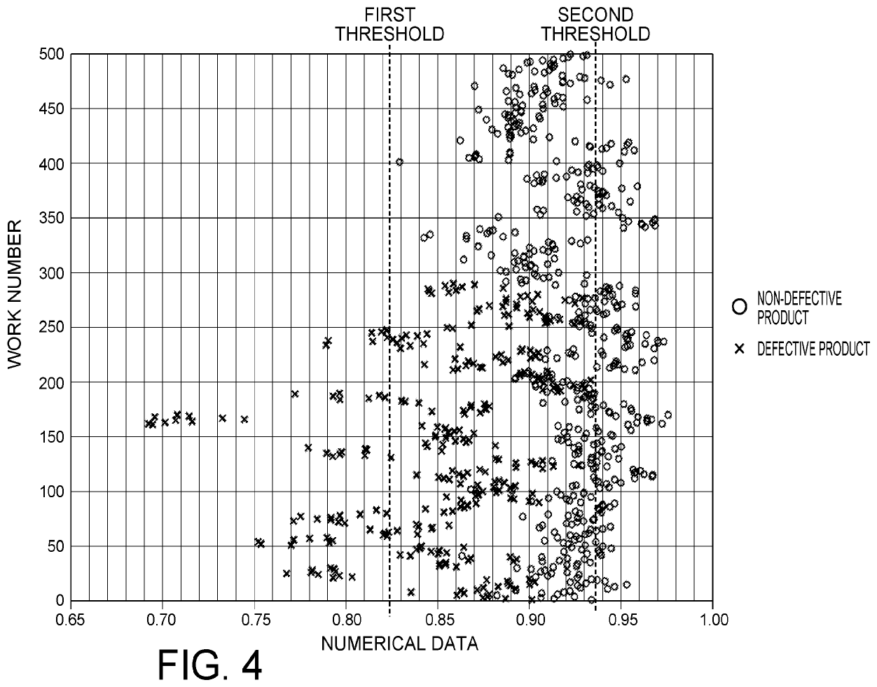

Therefore, the following measure may be taken: the AI processing unit 3 of the present embodiment sets the first threshold and the second threshold calculated by the threshold calculation unit 15, in an area where non-defective products and defective products are mixed as shown in FIG. 4; and the numerical data is compared with the first threshold and the second threshold to determine whether automatic determination is performed or not. More specifically, the AI processing unit 3 automatically determines that the product is a defective product when the numerical data is less than the first threshold, and the AI processing unit 3 automatically determines that the product is a non-defective product when the numerical data is greater than the second threshold. Alternatively, when the numerical data is between the first threshold and the second threshold, the AI processing unit 3 determines to perform the inspection of whether a non-defective product or a defective product by a person (worker) instead of performing the automatic determination by the AI processing unit 3.

Next, a processing operation of the inspection device 1 will be described in more detail. Hereinafter, making a determination of a non-defective product may be referred to as “OK”, and making a determination of a defective product may be referred to as “NG”.

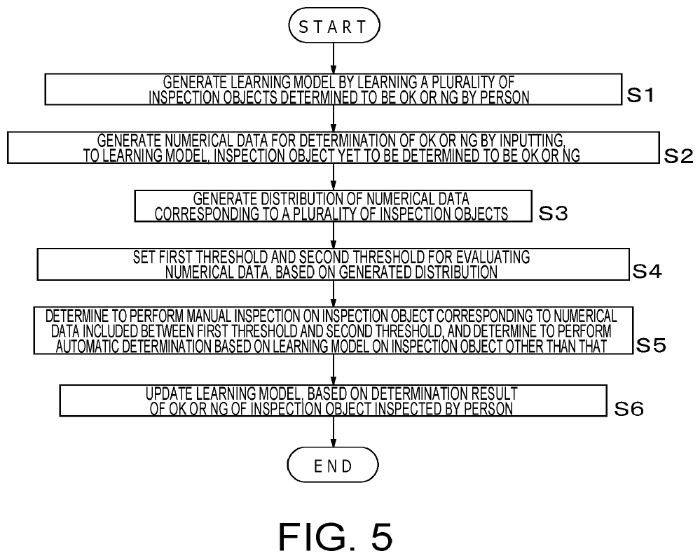

FIG. 5 is a flowchart illustrating the processing operation of the inspection device 1 according to the first embodiment. First, a learning model is generated by learning a plurality of inspection objects 5 that have been determined to be OK or NG by a person (worker) (step S1). This processing in step S1 is performed by the learning unit 11. It is assumed that supervised learning is performed in step S1; however, if unsupervised learning is performed, a learning model is generated by performing, instead of step S1, learning by clustering processing, a principal component analysis, or the like of inspection object data corresponding to a plurality of inspection objects 5, for example.

If the processing of step S1 is finished, next, the inspection object data photographed by the photographing unit 6 about the inspection object 5 that is not determined to be OK or NG is input to the learning model generated in step S1, and numerical data for determination of OK or NG is generated (step S2). Next, a distribution of numerical data corresponding to the plurality of inspection objects 5 is generated (step S3). This processing is performed by the determination unit 13, for example. The distribution is a distribution of plots on a two-dimensional coordinate plane as illustrated in FIGS. 3 and 4.

Next, the first threshold and the second threshold for evaluating numerical data are generated based on the generated distribution (step S4). The processing in step S4 is performed by the threshold calculation unit 15.

Next, when the numerical data generated in step S2 is between the first threshold and the second threshold, it is determined to perform the manual inspection, and when the numerical data is less than the first threshold or greater than the second threshold, it is determined to perform the automatic determination of a non-defective product or a defective product by the AI processing unit 3 (step S5). The processing in step S5 is performed by the determination unit 13. More specifically, the determination unit 13 determines that the product is a defective product when the numerical data is less than the first threshold, and the determination unit 13 determines that the product is a non-defective product when the numerical data is greater than the second threshold.

Next, on the basis of the determination in step S5, the result of the determination of a non-defective product or a defective product performed by the AI processing or by a person is input to the learning unit 11 together with the numerical data to update the learning model (step S6).

By repeating the process of steps S1 to S6 of FIG. 5, the learning model is repeatedly updated, and the number of plots between the first threshold and the second threshold illustrated in FIG. 4 can be reduced, so that a rate of a manual inspection can be reduced.

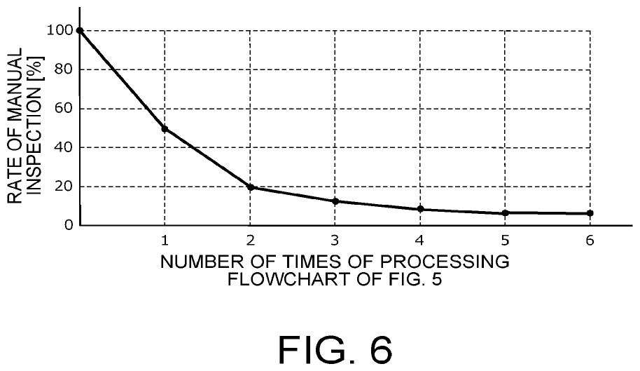

FIG. 6 is a graph illustrating how the rate of a manual inspection decreases by repeating learning on the basis of the flowchart of FIG. 5. The horizontal axis of the graph of FIG. 6 represents a number of times of processing of the flowchart of FIG. 5, and the vertical axis represents the rate [%] of a manual inspection. As the number of times of processing of the flowchart increases, the result of the determination of a non-defective product or a defective product performed by the AI processing and the result of the manual inspection of whether a non-defective product or a defective product get closer to each other, so that it is possible to make smaller the range of the numerical data in which non-defective products and defective products are mixed, in other words, it is possible to reduce a distance between the first threshold and the second threshold, whereby the rate of a manual inspection can be reduced.

As described above, in the first embodiment, based on the result of comparison of the numerical data calculated by inputting the inspection objects 5 to the learning model with the thresholds, it is determined whether to perform an automatic determination of a non-defective product or defective product, based on numerical data, or to perform a manual inspection of whether a non-defective product or a defective product. That is, in the present embodiment, since the manual inspection is performed only when the AI processing cannot automatically determine accurately whether a non-defective product or a defective product, the rate of a manual inspection can be reduced as the learning model is further updated. As described above, in the present embodiment, the AI processing does not perform all the inspections when the inspection processing is performed, but the rate of a manual inspection is changed depending on a degree of update of the learning model; therefore, the inspection accuracy of the AI processing can be gradually improved instead of lowering the inspection accuracy, and the rate of a manual inspection can be gradually reduced accordingly.

### Second Embodiment

In the second embodiment, it is determined whether the learning model has reached a practical level. In order to use the learning model generated by the learning unit 11 according to the first embodiment for inspection of actual products, it is necessary to repeatedly update the learning model to reduce the number of plots located between the first threshold and the second threshold in FIG. 4 to such an extent that there is no practical problem.

An inspection device 1 according to the second embodiment has a block configuration similar to that in FIG. 1, but the internal configuration of an AI processing unit 3 is partially different from that in FIG. 2.

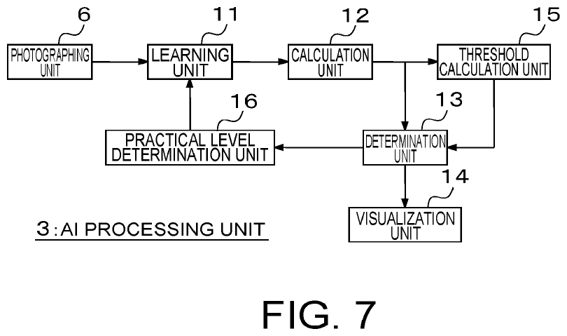

FIG. 7 is a block diagram illustrating the internal configuration of the AI processing unit 3 according to the second embodiment. The AI processing unit 3 of FIG. 7 includes a practical level determination unit 16 in addition to the configuration of FIG. 2.

The practical level determination unit 16 determines whether a rate of the numerical data included between the first threshold and the second threshold in the distribution of the plots as illustrated in FIG. 4 has become less than a third threshold; and when it is determined that the rate is less than the third threshold, the practical level determination unit 16 determines that the learning model has reached a practical level, and when it is determined that the rate is equal to or greater than the third threshold, the practical level determination unit 16 determines that the learning model has not yet reached the practical level. Here, the rate is a ratio of the number of pieces of the numerical data between the first threshold and the second threshold to the total number of pieces of numerical data.

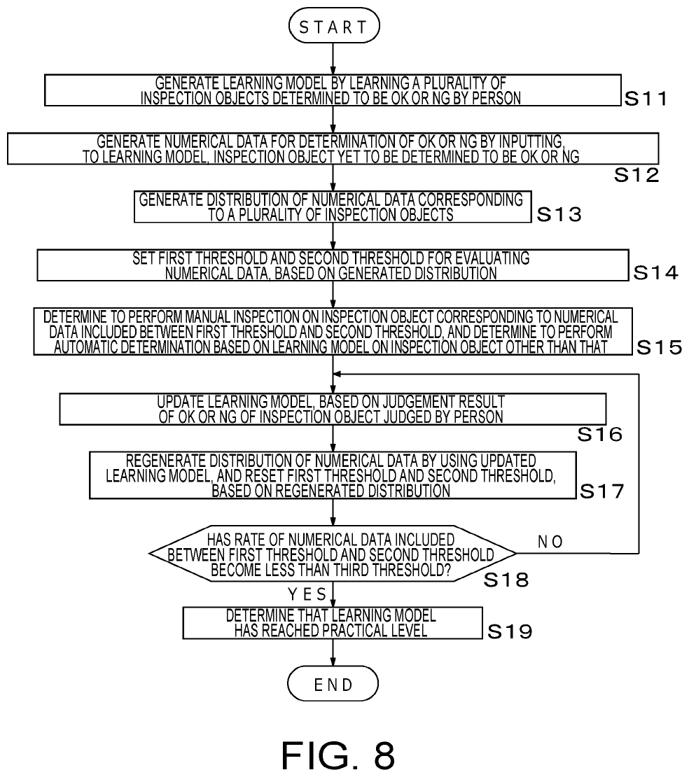

FIG. 8 is a flowchart illustrating a processing operation of the inspection device 1 according to the second embodiment. Steps S11 to S16 are the same as steps S1 to S6 in FIG. 5. After the learning model is updated in step S16, the distribution of the numerical data of the inspection objects 5 is regenerated using the updated learning model, and the first threshold and the second threshold are reset based on the regenerated distribution (step S17). The processing in step S17 is performed by, for example, the determination unit 13 and the threshold calculation unit 15. In general, when the learning model is updated, the distance between the first threshold and the second threshold is reset to be smaller. As a result, the number of plots between the first threshold and the second threshold decreases.

Next, it is determined whether the rate of the numerical data included between the first threshold and the second threshold has become less than the third threshold (step S18). When the rate is still more than or equal to the third threshold, the flow returns to step S16, and the learning model is continuously updated. On the other hand, if it is determined in step S18 that the rate has become less than the third threshold, it is determined that the learning model has reached the practical level (step S19). The processing in steps S18 and S19 is performed by the practical level determination unit 16.

As described above, in the second embodiment, when the rate of the numerical data between the first threshold and the second threshold in the distribution of the plots has become less than the third threshold, it is determined that the learning model has reached the practical level; therefore, it is possible to simply and accurately determine whether the learning model should be used for inspection of actual products.

When it is determined in step S19 of FIG. 7 that the learning model has reached the practical level, the processing of steps S4 to S6 of FIG. 1 is performed, using an actual product as the inspection object 5. That is, also when it is determined that the learning model has reached the practical level, the learning model is updated every time a new inspection object 5 is inspected, so that the inspection accuracy of the learning model can be further improved and the rate of a manual inspection can be further reduced.

### Third Embodiment

In the third embodiment, it is determined whether the numerical data between the first threshold and the second threshold is a non-defective product or a defective product, taking defect information into consideration. In a case where there is a defect such as a flaw on the surface of the inspection object 5, it is usually determined that the inspection object 5 is a defective product if the defect size exceeds a predetermined size. However, if the defect does not affect an operation or function of the inspection object 5, the inspection object 5 may be treated as a non-defective product.

Therefore, in the present embodiment, regarding the numerical data between the first threshold and the second threshold in the plot diagram as illustrated in FIG. 4, a relearning model is generated by relearning while taking defect information such as a defect size into consideration, and the numerical data is output again on the basis of a result of calculation by inputting inspection object data to the generated relearning model. Specifically, the determination unit 13 of the present embodiment determines, based on the first threshold and the second threshold set for each type of unique information of inspection objects, whether to automatically discriminate the type of the inspection object or to manually discriminate the type of the inspection object for the each type of the unique information of the inspection object. Here, the unique information is arbitrary information that characterizes the inspection object, and is a general idea including defect information such as the above-described defect size.

The inspection device 1 according to the third embodiment has a block configuration similar to that in FIG. 1, but an internal configuration of an AI processing unit 3 is partially different from that in FIG. 2.

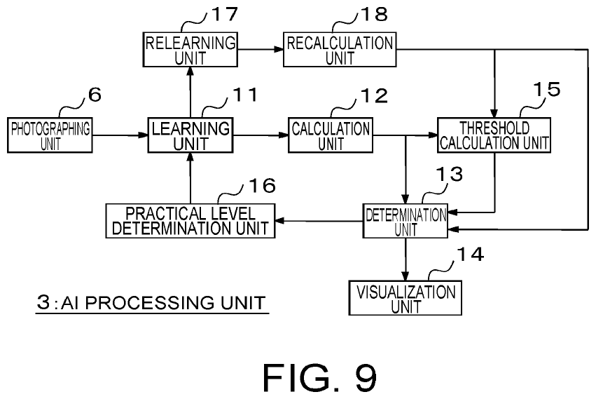

FIG. 9 is a block diagram illustrating the internal configuration of the AI processing unit 3 according to the third embodiment. The AI processing unit 3 of FIG. 9 includes a relearning unit 17 and a recalculation unit 18 in addition to the configuration of FIG. 7.

When there is numerical data between the first threshold and the second threshold, the relearning unit 17 generates the relearning model by performing relearning based on defect information of a non-defective product and a defective product. The defect information is, for example, a defect size of an inspection object 5. The defect size of the inspection object 5 can be acquired from the photographed image photographed by the photographing unit 6. More specifically, a subtraction image between a reference photographed image having no defect and a photographed image of the inspection object 5 can be taken as a defect, and a size of the defect can be the defect size. Alternatively, the defect size in the inspection object 5 may be previously measured by a worker, and the measured defect size may be input to the relearning unit 17 separately from the photographed image to generate the relearning model.

The recalculation unit 18 outputs again the numerical data on the basis of the result of calculation by inputting the inspection object data to the relearning model. The recalculation unit 18 specifies the defect included in the photographed image of the inspection object 5 by the above-described method, and inputs the defect size to the relearning model to calculate the numerical data.

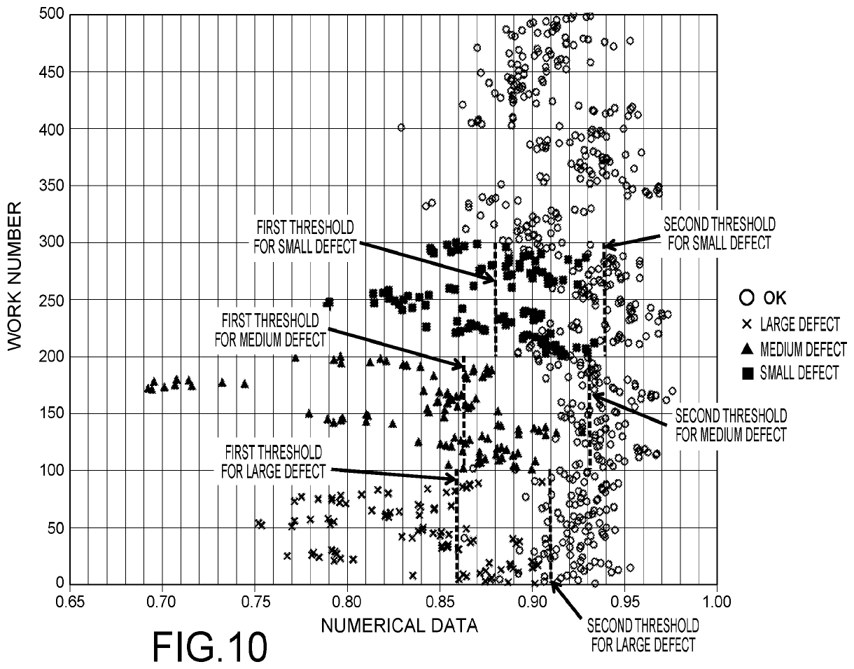

FIG. 10 is a plot diagram illustrating inspection results of a plurality of inspection objects 5. In FIG. 10, the horizontal axis represents numerical data calculated by the calculation unit 12, and the vertical axis represents the work number of each inspection object 5. FIG. 10 illustrates the following four types of plots: plot ◯ representing the worker's judgment of a non-defective product; plot × representing a large-sized defect and the judgment of a defective product; plot ▴ representing a medium-sized defect and the judgment of a defective product; and plot ▪ representing a small-sized defect and the judgment of a defective product.

As illustrated in FIG. 10, the numerical data related to the judgment of a non-defective product or a defective product is different depending on the defect size, and the area of the numerical data that is sometimes judged to be non-defective or sometimes judged to be defective is also different depending on the defect size. FIG. 10 illustrates an example in which the first threshold and the second threshold are separately set for each of three defect sizes of large, medium, and small. For each defect size, numerical data less than the first threshold is automatically determined to be a defective product, numerical data larger than the second threshold is automatically determined to be a non-defective product, and numerical data from the first threshold to the second threshold indicates that the manual inspection of whether a non-defective product or a defective product is performed instead of performing the automatic determination by the AI processing.

As can be seen from FIG. 10, regarding the inspection objects 5 containing large-sized or medium-sized defects, the rate of the numerical data that is determined to be sometimes a non-defective product or sometimes a defective product to the total number of pieces of numerical data is not so large. On the other hand, regarding the inspection objects 5 containing small-sized defect, the rate of the numerical data that is sometimes determined to be sometimes a non-defective product or sometimes a defective product to the total number of pieces of numerical data is very large. Therefore, the processing may be separately performed depending on whether the size of the defect contained in the inspection object 5 is small. Specifically, when the defect size is not a small size, it is possible to determine, based on the comparison result using the previously set first threshold and the second threshold, to perform the automatic discrimination based on the AI processing or to perform the manual discrimination; and when the defect size is a small size, the first threshold and the second threshold may be set again.

Note that, since the small-sized defect often does not affect an inherent operation or function of the inspection object 5, the small-sized defect may not be treated as defective.

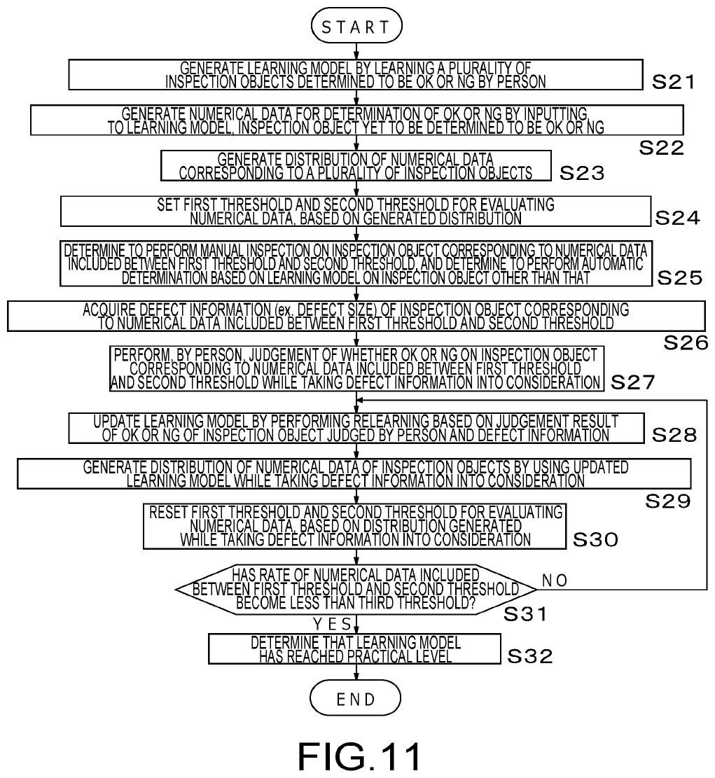

FIG. 11 is a flowchart illustrating a processing operation of the inspection device 1 according to the third embodiment. Steps S21 to S25 are the same as steps S1 to S5 in FIG. 5. When the determination in step S25 is made, the defect information of the inspection object 5 corresponding to the numerical data included between the first threshold and the second threshold is acquired (step S26). To acquire the defect size as the defect information, the defect size can be acquired, as described above, from the subtraction image between the photographed image without a defect and the photographed image of the inspection object 5. Alternatively, the worker may input the defect size.

Next, the worker determines whether the inspection object 5 corresponding to the numerical data included between the first threshold and the second threshold is a non-defective product or a defective product in consideration of the defect information (step S27).

Next, on the basis of the determination result of step S27 and the defect information, the relearning unit 17 performs relearning to generate the relearning model (step S28).

Next, the distribution of the numerical data of the inspection objects 5 is generated using the updated learning model in consideration of the defect information (step S29). The processing in step S29 is performed by the determination unit 13, and a plot diagram as illustrated in FIG. 10 is generated, for example.

Next, the first threshold and the second threshold are reset based on the distribution generated in consideration of the defect information (step S30). The processing in step S30 is performed by the determination unit 13 and the threshold calculation unit 15, and, for example, the first threshold and the second threshold indicated by broken lines as in FIG. 10 are reset.

Next, it is determined whether the rate of the numerical data included between the first threshold and the second threshold has become less than the third threshold (step S31). If the rate is not less than the third threshold, the processing in and after step S28 is repeatedly performed, and if it is less than the third threshold, it is determined that the learning model has reached the practical level (step S32).

As described above, in the third embodiment, in a case where it is difficult to discriminate whether a non-defective product or a defective product, the relearning is performed in consideration of the defect information such as the defect size, so that the first threshold and the second threshold for discriminating whether a non-defective product or a defective product can be set based on the inspection object 5 whose defect size is large to a certain extent or larger. Therefore, the rate of the numerical data included between the first threshold and the second threshold can be reduced, and the rate of a manual inspection can be reduced without lowering the inspection accuracy.

### Fourth Embodiment

The first to third embodiments have described the examples in which when the numerical data is between the first threshold and the second threshold, the manual inspection of whether a non-defective product or a defective product is performed; however, it is also possible to determine, depending on a frequency at which the numerical data is classified into the non-defective product or the defective product, whether to perform the manual inspection of whether a non-defective product or a defective product or not.

An inspection device 1 according to a fourth embodiment has a block configuration similar to that in FIG. 1, and an AI processing unit 3 has a block configuration similar to that in FIG. 2 or 7.

In the AI processing unit 3 according to the fourth embodiment, a processing operation of a determination unit 13 is different from the processing operation of the determination unit 13 according to the first to third embodiments. In the present embodiment, it is a precondition that classification is performed a plurality of times, based on a plurality of pieces of inspection object data obtained by photographing each inspection object 5 a plurality of times. The determination unit 13 according to the fourth embodiment determines to manually determine the type of the inspection object when a frequency at which the inspection object 5 is classified into a specific type is more than or equal to a fourth threshold and less than a fifth threshold when the same inspection object 5 is classified a plurality of times.

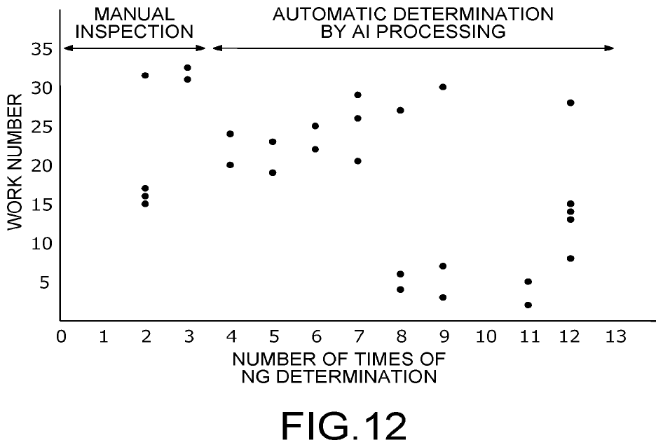

FIG. 12 is a plot diagram illustrating results of photographing each of a plurality of inspected objects a plurality of times (for example, 15 times) and performing a discrimination of whether a non-defective product or a defective product based on a plurality of pieces of photographed image data of each inspection object 5. In FIG. 12, the horizontal axis represents the number of times of determination of a defective product, and the vertical axis represents an identification number (work number) of each inspected object. Each plot in FIG. 12 represents a different inspected object, and is plotted at the position representing the number of times the inspected object was determined to be a defective product as a result of performing a discrimination of whether a non-defective product or a defective product a plurality of times.

Because it is no problem to determine to be a defective product an inspected object which is determined to be a defective product a predetermined number of times or more with respect to a total number of times of performing the discrimination of whether a non-defective product or a defective product on each inspected object, the determination unit 13 of the present embodiment determines to perform the automatic determination by the AI processing on the inspected object that is determined to be a defective product the predetermined number of times or more On the other hand, for the inspected object that is determined to be a defective product less than a predetermined number of times, it is determined to perform a manual inspection. Determining, based on the predetermined number of times with respect to the total number of times, whether or not to perform a manual inspection means determining, based on a frequency of being discriminated into a defective product or a non-defective product, whether or not to perform a manual inspection.

As described above, in the fourth embodiment, in a case where there is a variation in determination of a non-defective product or a defective product, it is possible to determine, depending on a frequency of the variation, whether or not to perform a manual inspection; therefore, it is possible to determine whether or not to perform a manual inspection, without setting two or more thresholds.

At least a part of the inspection device 1 and the inspection method described in the above-described embodiments may be configured with hardware or software. In the case where software is used for the configuration, a program that realizes at least some functions of the inspection device 1 and the inspection method may be stored in a recording medium such as a flexible disk or a CD-ROM, and may be read and executed by a computer. The recording medium is not limited to a removable recording medium such as a magnetic disk or an optical disk, and may be a fixed recording medium such as a hard disk device or a memory.

In addition, a program that implements at least some of the functions of the inspection device 1 and the inspection method may be distributed via a communication line (including wireless communication) such as the Internet. Further, the program may be distributed via a wired line or a wireless line such as the Internet or may be stored in a recording medium in an encrypted, modulated, or compressed state.

Further, the AI processing unit 3 according to each of the above-described embodiments may be connected to a predetermined network such as a public line or a dedicated line such as the Internet, and teacher data and inspection object data may be transmitted to the AI processing unit 3 via the network, so that a result of AI processing executed by the AI processing unit 3 may be received via the network. As described above, at least some constituent parts in the inspection device 1 may be provided in a cloud environment.

Aspects of the present invention are not limited to the above-described individual embodiments, but include various modifications that can be conceived by those skilled in the art, and the effects of the present invention are not limited to the above-described contents. That is, various additions, modifications, and partial deletions can be made without departing from the conceptual idea and gist of the present invention derived from the contents defined in the claims and equivalents thereof.

For example, in the third embodiment described above, the defect size of the inspection object 5 is exemplified as the defect information, but the defect information is not limited thereto, and a defect position (a position of a defect in an inspection object 5) or the like may be used as the defect information.

In addition, each of the above-described embodiments has described the example in which the control unit 2 generates the teacher data and the inspection object data, but the present invention is not limited thereto; for example, a photographed image photographed by the photographing unit 6 may be transmitted to the AI processing unit 3, and the AI processing unit 3 may generate the teacher data and the inspection object data. In this case, since the photographed image photographed by the photographing unit 6 is transmitted to the AI processing unit 3 without passing through the control unit 2, it is possible to easily and quickly generate the teacher data and the inspection object data as compared with each embodiment described above.

Further, each of the above-described embodiments has described the case where the learning unit 11 or the relearning unit 17 of the AI processing unit 3 generates the learning model and the relearning model, but the present invention is not limited thereto, and for example, the learning unit 11 or the relearning unit 17 may acquire the learning model and the relearning model generated by a unit other than the AI processing unit 3. In this case, because the processing performed by the learning unit 11 and the relearning unit 17 can be simplified, a processing load of the AI processing unit 3 can be reduced as compared with each embodiment described above.

Further, each of the above-described embodiments has described the example in which the generation of the distribution of the numerical data (steps S3, S13, S17, S23, and S29), the setting of the first threshold and the second threshold (steps S4, S14, S17, S24, and S30), and the update of the learning model (steps S6, S16, and S28) are each executed in the processing operation of the inspection device 1; however, the present invention is not limited thereto, and for example, these steps may be omitted, and it is also possible to determine, on the basis of a previously set threshold, whether to perform an automatic determination or to perform a manual inspection.

### REFERENCE SIGNS LIST

1 inspection device
2 control unit
3 AI processing unit
4 information processing unit
4a display unit
5 inspection object
6 photographing unit
7 storage body
8 rotary stage
9 robot
11 learning unit
12 calculation unit
13 determination unit
14 visualization unit
15 threshold calculation unit
16 practical level determination unit
17 relearning unit
18 recalculation unit

1. An inspection device comprising:
a learning unit that generates a learning model by performing learning for discriminating a type of an inspection object by using as teacher data at least a part of classification results obtained by classifying a plurality of inspected objects of a same type as an inspection object into a plurality of types, or acquires the learning model;
a calculation unit that outputs numerical data obtained by quantifying a level of classification accuracy of the type of the inspection object, based on a result calculated by inputting the inspection object to the learning model; and
a determination unit that determines, based on a result of comparing the numerical data with one or more types of thresholds, whether to automatically discriminate the type of the inspection object or to manually discriminate the type of the inspection object.

2-3. (canceled)

4. The inspection device according to claim 1, wherein
the one or more types of thresholds include a first threshold and a second threshold larger than the first threshold, and
when the numerical data is between the first threshold and the second threshold, the determination unit determines to manually discriminate the type of the inspection object.

5. The inspection device according to claim 4, wherein when the numerical data is smaller than the first threshold or the numerical data is larger than the second threshold, the determination unit determines to automatically discriminate the type of the inspection object instead of manually discriminating the type of the inspection object.

6. The inspection device according to claim 4, comprising:
a relearning unit that, when the numerical data is between the first threshold and the second threshold, generates a relearning model by performing relearning, based on unique information of the inspection object or acquires the relearning model; and
a recalculation unit that outputs again the numerical data, based on a result calculated by inputting the inspection object to the relearning model, wherein
the determination unit determines, while taking into consideration the unique information of the inspection object, whether to automatically discriminate the type of the inspection object based on a result of comparing the numerical data with the first threshold and the second threshold or to manually discriminate the type of the inspection object.

7. The inspection device according to claim 6, wherein the determination unit determines, based on the first threshold and the second threshold set for each type of the unique information of the inspection object, whether to automatically discriminate the type of the inspection object for the each type of the unique information of the inspection object or to manually discriminate the type of the inspection object.

8. The inspection device according to claim 6, wherein
the plurality of types include a non-defective type and a defective type, and
the unique information includes defect sizes of a non-defective product and a defective product.

9. The inspection device according to claim 4, comprising a practical level determination unit that determines whether a rate of the numerical data included between the first threshold and the second threshold has become less than a third threshold and that determines, when the rate is determined to have become less than the third threshold, that the learning model has reached a practical level.

10-12. (canceled)

13. An inspection method for inspecting an inspection object performed by a computer, the inspection method performed by a computer, comprising:
generating a learning model by performing learning for discriminating a type of an inspection object by using as teacher data at least a part of classification results obtained by classifying a plurality of inspected objects of a same type as the inspection object into a plurality of types, or acquiring the learning model;
outputting numerical data obtained by quantifying a level of classification accuracy of the type of the inspection object, based on a result calculated by inputting the inspection object to the learning model; and
determining, based on a result of comparing the numerical data with one or more types of thresholds, whether to automatically discriminate the type of the inspection object or to manually discriminate the type of the inspection object.

14. The inspection method according to claim 13, wherein
the computer connected to a network is configured to:
transmit the teacher data and the data of the inspection object to the computer via the network, and
receive, via the network, information on whether to automatically discriminate the type of the inspection object or to manually discriminate the type of the inspection object, the information being determined by the computer.

15. The inspection method according to claim 13, wherein the computer is configured to calculate the one or more types of thresholds, based on a plurality of pieces of the numerical data calculated by inputting a plurality of the inspection objects to the learning model.

16. The inspection method according to claim 15, wherein the computer is configured to calculate the one or more types of thresholds by statistically processing the plurality of pieces of the numerical data.

17. The inspection method according to claim 13, wherein
the one or more types of thresholds include a first threshold and a second threshold larger than the first threshold, and
the computer is configured to determine to manually discriminate the type of the inspection object when the numerical data is between the first threshold and the second threshold.

18. The inspection method according to claim 17, wherein the computer is configured to determine, when the numerical data is smaller than the first threshold or the numerical data is larger than the second threshold, to automatically discriminate the type of the inspection object instead of manually discriminating the type of the inspection object.

19. The inspection method according to claim 17, wherein the computer is configured to:
generate, when the numerical data is between the first threshold and the second threshold, a relearning model by performing relearning based on unique information of the inspection object or acquiring the relearning model;
output again the numerical data, based on a result calculated by inputting the inspection object to the relearning model; and
determine, while taking into consideration the unique information of the inspection object, whether to automatically discriminate the type of the inspection object based on a result of comparing the numerical data with the first threshold and the second threshold or to manually discriminate the type of the inspection object.

20. The inspection method according to claim 19, wherein the computer is configured to determine, based on the first threshold and the second threshold set for each type of the unique information of the inspection object, whether to automatically discriminate the type of the inspection object for each type of the unique information of the inspection object or to manually discriminate the type of the inspection object.

21. The inspection method according to claim 19, wherein
the plurality of types include a non-defective type and a defective type, and
the unique information includes defect sizes of a non-defective product and a defective product.

22. The inspection method according to claim 17, the computer is configured to determine whether a rate of the numerical data included between the first threshold and the second threshold has become less than a third threshold, and determine, when the rate is determined to have become less than the third threshold, that the learning model has reached a practical level.

23. The inspection method according to claim 13, the computer is configured to determine to manually discriminate the type of the inspection object, in a case where a frequency at which the inspection object is classified into a specific type is less than a fourth threshold when classification of the same inspection object has been performed a plurality of times.

24. The inspection method according to claim 13, wherein a plurality of photographed images of the inspection object photographed from a plurality of directions is used as the teacher data.

25. The inspection method according to claim 13, the computer is configured to visualize the numerical data calculated by inputting a plurality of inspection objects to the learning model.
